(19) United States
(12) Patent Application Publication
(10) Pub. No.: US 2024/0113314 A1
(43) Pub. Date: Apr. 4, 2024

(54) FLOW BATTERY AND CELL STACK

(71) Applicant: Hunan Province Yinfeng New Energy Co., Ltd, Changsha City (CN)

(72) Inventors: Xiongwei WU, Changsha City (CN); Bo XIAO, Changsha City (CN); Jun LIU, Changsha City (CN); Xuewen WU, Changsha City (CN); Xuanzhi XIE, Changsha City (CN); Xingrong YIN, Changsha City (CN); Jie ZHANG, Changsha City (CN)

(21) Appl. No.: 18/213,173

(22) Filed: Jun. 22, 2023

(30) Foreign Application Priority Data
Sep. 30, 2022 (CN) 202211209316.2

(51) Int. Cl. H01M 8/04082; H01M 8/18; H01M 8/2465

(52) U.S. Cl. CPC H01M 8/04201; H01M 8/188; H01M 8/2465

(57) ABSTRACT

The present disclosure provides a flow battery and a cell stack. The cell stack includes: a first end plate; a second end plate; and at least one cell module arranged between the first end plate and the second end plate. Each cell module includes a first flow channel end plate, a second flow channel end plate arranged opposite to the first flow channel end plate, and single-cell assemblies arranged between the first flow channel end plate and the second flow channel end plate. The single-cell assemblies include at least three hermetically-assembled cell assemblies, the first flow channel end plate is provided with arch-like flow channels, the second flow channel end plate is provided with arch-like flow channels, and each arch-like flow channel is provided with a flow channel aperture in communication with the at least three hermetically-assembled cell assemblies.

### TECHNICAL FIELD

The present disclosure relates to the field of flow cell technology, in particular to a flow battery and a cell stack.

### BACKGROUND

Fossil energy resources will be exhausted inevitably, and renewable energy sources, such as solar energy and wind energy, have attracted more and more attention. However, the renewable energy resources are usually discontinuous, and a serious impact may be caused on the electricity grid due to the instability. Through the flow cell energy storage technology, it is able for the renewable energy resources to achieve peak-load shifting in a better manner.

A flow cell stack is a core component of a flow cell energy storage system, and the cost performance of the energy storage system depends on the performance of the flow cell stack.

Currently, in order to improve electric energy conversion efficiency, usually a length of an electrode through which an electrolyte flows needs to be reduced. However, an area of the electrode needs to be increased to provide same power, i.e., the length of the electrode needs to be increased. In the case of a longer electrode, there is a challenge for the sealing of a flow channel of the electrode. Currently, it is impossible for the flow cell to meet the requirement on actual power as well as the sealing of the flow channel.

### SUMMARY

An object of the present disclosure is to provide a flow battery and a cell stack, so as to improve the electric energy conversion efficiency.

In order to solve the above-mentioned problem, the present disclosure provides the following technical solutions.

In one aspect, the present disclosure provides in some embodiments a cell stack of a flow battery, including: a first end plate; a second end plate; and at least one cell module arranged between the first end plate and the second end plate. Each cell module includes a first flow channel end plate, a second flow channel end plate arranged opposite to the first flow channel end plate, and single-cell assemblies arranged between the first flow channel end plate and the second flow channel end plate. The single-cell assemblies include at least three hermetically-assembled cell assemblies, the first flow channel end plate is provided with a first arch-like flow channel and a second arch-like flow channel, the second flow channel end plate is provided with a third arch-like flow channel and a fourth arch-like flow channel, each of the first arch-like flow channel, the second arch-like flow channel, the third arch-like flow channel and the fourth arch-like flow channel is provided with a flow channel aperture, each flow channel aperture is in communication with the at least three hermetically-assembled cell assemblies, an electrolyte in the first arch-like flow channel flows through the at least three hermetically-assembled cell assemblies via the flow channel aperture in the first arch-like flow channel to the second arch-like flow channel, and an electrolyte in the third arch-like flow channel flows through the at least three hermetically-assembled cell assemblies via the flow channel aperture in the third arch-like flow channel to the fourth arch-like flow channel.

In another aspect, the present disclosure provides in some embodiments a flow battery including the above-mentioned cell stack.

The present disclosure at least has the above-mentioned beneficial effects.

According to the embodiments of the present disclosure, the cell stack includes: the first end plate; the second end plate; and the at least one cell module arranged between the first end plate and the second end plate. Each cell module includes the first flow channel end plate, the second flow channel end plate arranged opposite to the first flow channel end plate, and the single-cell assemblies arranged between the first flow channel end plate and the second flow channel end plate. The single-cell assemblies include at least three hermetically-assembled cell assemblies, the first flow channel end plate is provided with the first arch-like flow channel and the second arch-like flow channel, the second flow channel end plate is provided with the third arch-like flow channel and the fourth arch-like flow channel, each of the first arch-like flow channel, the second arch-like flow channel, the third arch-like flow channel and the fourth arch-like flow channel is provided with the flow channel aperture, each flow channel aperture is in communication with the at least three hermetically-assembled cell assemblies, the electrolyte in the first arch-like flow channel flows through the at least three hermetically-assembled cell assemblies via the flow channel aperture in the first arch-like flow channel to the second arch-like flow channel, and the electrolyte in the third arch-like flow channel flows through the at least three hermetically-assembled cell assemblies via the flow channel aperture in the third arch-like flow channel to the fourth arch-like flow channel. As a result, it is able to increase a length of an electrode in the flow battery along with an increase in the quantity of flow channel apertures, adjust the length of the electrode randomly in the case of same output power and a same area of the electrode, and narrow a path of the electrolyte flowing through the electrode, thereby to improve the electric energy conversion efficiency and improve the sealability of the flow channels.

### BRIEF DESCRIPTION OF THE DRAWINGS

FIG. 1 is a solid view of a cell stack of a flow battery according to one embodiment of the present disclosure;

FIG. 2 is a solid view of an individual cell module of the cell stack according to one embodiment of the present disclosure;

FIG. 3 is an exploded view of the individual cell module of the cell stack according to one embodiment of the present disclosure;

FIG. 4 is a perspective view of a first flow channel end plate of the cell stack according to one embodiment of the present disclosure;

FIG. 5 is a sectional view of the first flow channel end plate of the cell stack according to one embodiment of the present disclosure;

FIG. 6 is a sectional view of a second flow channel end plate of the cell stack according to one embodiment of the present disclosure;

FIG. 7 is a schematic view showing a first cell assembly of an individual cell module of the cell stack according to one embodiment of the present disclosure;

FIG. 8 is a schematic view showing a first end surface of a first outer frame of the first cell assembly according to one embodiment of the present disclosure;

FIG. 9 is a schematic view showing a second end surface of the first outer frame of the first cell assembly according to one embodiment of the present disclosure;

FIG. 10 is a schematic view showing a first end surface of a second outer frame of the first cell assembly according to one embodiment of the present disclosure;

FIG. 11 is a schematic view showing a second end surface of the second outer frame of the first cell assembly according to one embodiment of the present disclosure;

FIG. 12 is a schematic view showing a second cell assembly of the individual cell module of the cell stack according to one embodiment of the present disclosure;

FIG. 13 is a schematic view showing a second end surface of a third outer frame of the second cell assembly according to one embodiment of the present disclosure;

FIG. 14 is a schematic view showing a first end surface of the third outer frame of the second cell assembly according to one embodiment of the present disclosure;

FIG. 15 is a schematic view showing a third cell assembly of the individual cell module of the cell stack according to one embodiment of the present disclosure;

FIG. 16 is a schematic view showing a second end surface of a fifth outer frame of the third cell assembly according to one embodiment of the present disclosure;

FIG. 17 is a schematic view showing a first end surface of the fifth outer frame of the third cell assembly according to one embodiment of the present disclosure;

FIG. 18 is a sectional view of the fifth outer frame of the third cell assembly according to one embodiment of the present disclosure;

FIG. 19 is a schematic view showing a second end surface of a sixth outer frame of the third cell assembly according to one embodiment of the present disclosure;

FIG. 20 is a schematic view showing a first end surface of the sixth outer frame of the third cell assembly according to one embodiment of the present disclosure;

FIG. 21 is a sectional view of the sixth outer frame of the third cell assembly according to one embodiment of the present disclosure;

FIG. 22 is a sectional view of the cell stack after the assembling of the fifth outer frame, a second inner frame and a fourth bipolar plate according to one embodiment of the present disclosure;

FIG. 23 is a sectional view of the cell stack after the assembling of a fifth inner frame, the sixth outer frame and a third separator according to one embodiment of the present disclosure;

FIG. 24 is a solid view of two third cell assemblies of the cell stack according to one embodiment of the present disclosure;

FIG. 25 is a schematic view showing a second end surface of a first inner frame and a second end surface of the fifth inner frame according to one embodiment of the present disclosure;

FIG. 26 is a schematic view showing a first end surface of the first inner frame and a first end surface of the fifth inner frame according to one embodiment of the present disclosure;

FIG. 27 is a sectional view of the first inner frame and the fifth inner frame according to one embodiment of the present disclosure;

FIG. 28 is a schematic view showing a second end surface of a second inner frame and a second end surface of a sixth inner frame according to one embodiment of the present disclosure;

FIG. 29 is a schematic view showing a first end surface of the second inner frame and a first end surface of the sixth inner frame according to one embodiment of the present disclosure;

FIG. 30 is a sectional view of the second inner frame and the sixth inner frame according to one embodiment of the present disclosure;

FIG. 31 is a sectional view of a cavity between the inner frame and the outer frame according to one embodiment of the present disclosure; and

FIG. 32 is a sectional view of the second outer frame at a fourth inlet flow channel and a third inlet flow channel according to one embodiment of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure. Actually, the embodiments are provided so as to facilitate the understanding of the scope of the present disclosure.

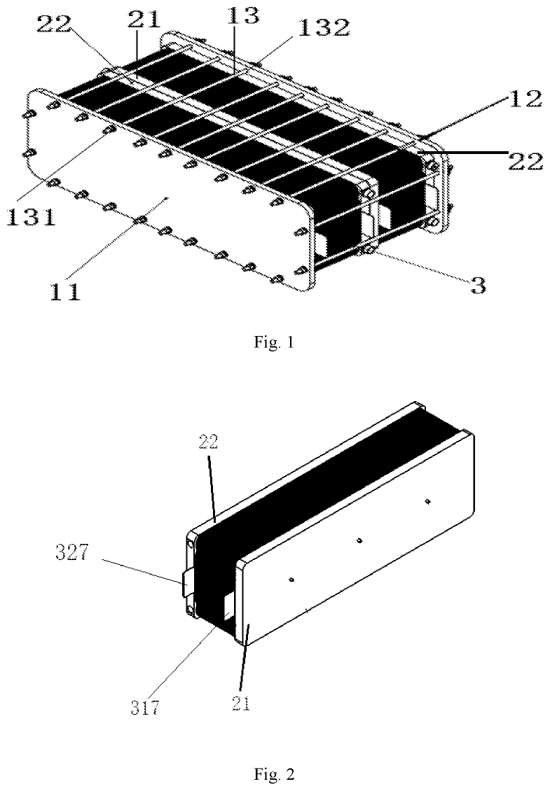

As shown in FIGS. 1 to 6, the present disclosure provides in some embodiments a cell stack of a flow battery, which includes: a first end plate 11; a second end plate 12; and at least one cell module arranged between the first end plate 11 and the second end plate 12. Each cell module includes a first flow channel end plate 21, a second flow channel end plate 22 arranged opposite to the first flow channel end plate 21, and single-cell assemblies 3 arranged between the first flow channel end plate 21 and the second flow channel end plate 22. The single-cell assemblies 3 include at least three hermetically-assembled cell assemblies, the first flow channel end plate 21 is provided with a first arch-like flow channel 24 and a second arch-like flow channel 25, the second flow channel end plate 22 is provided with a third arch-like flow channel 26 and a fourth arch-like flow channel 27, each of the first arch-like flow channel 24, the second arch-like flow channel 25, the third arch-like flow channel 26 and the fourth arch-like flow channel 27 is provided with a flow channel aperture, each flow channel aperture is in communication with the at least three hermetically-assembled cell assemblies, an electrolyte in the first arch-like flow channel 24 flows through the at least three hermetically-assembled cell assemblies via the flow channel aperture in the first arch-like flow channel 24 to the second arch-like flow channel 25, and an electrolyte in the third arch-like flow channel 26 flows through the at least three hermetically-assembled cell assemblies via the flow channel aperture in the third arch-like flow channel 26 to the fourth arch-like flow channel 27.

According to the embodiments of the present disclosure, it is able to increase a length of an electrode in the flow battery along with an increase in the quantity of flow channel apertures, adjust the length of the electrode randomly in the case of same output power and a same area of the electrode, and narrow a path of the electrolyte flowing through the electrode, thereby to improve the electric energy conversion efficiency and improve the sealability of the flow channels.

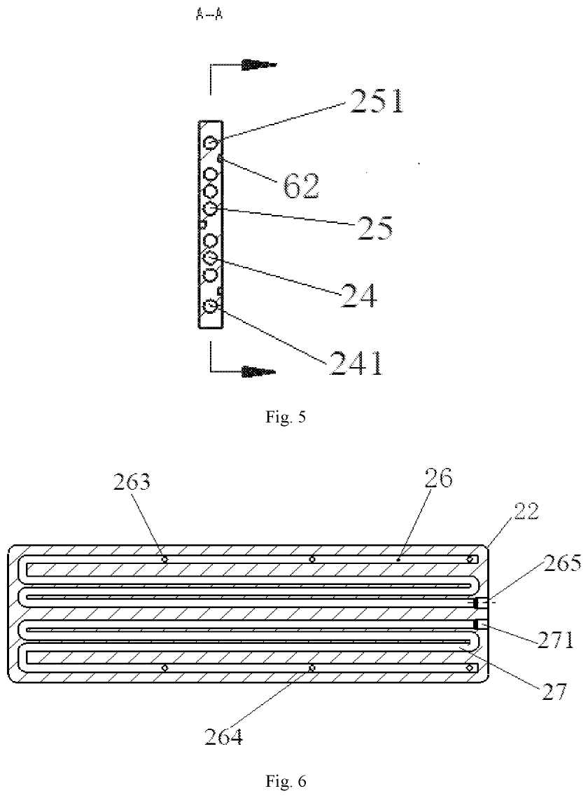

As shown in FIGS. 4 and 5, in a possible embodiment of the present disclosure, the flow channel apertures include a first flow channel aperture 261 formed in the first arch-like flow channel 24, a second flow channel aperture 262 formed in the second arch-like flow channel 25, a third flow channel aperture 263 formed in the third arch-like flow channel 26, and a fourth flow channel aperture 264 formed in the fourth arch-like flow channel 27. When a positive electrolyte is injected into the first arch-like flow channel 24 in the first flow channel end plate 21, a negative electrolyte is injected into the third arch-like flow channel 26 in the second flow channel end plate 22. In contrast, when the negative electrolyte is injected into the first arch-like flow channel 24 in the first flow channel end plate 21, the positive electrolyte is injected into the third arch-like flow channel 26 in the second flow channel end plate 22.

In the embodiments of the present disclosure, after the positive electrolyte has been injected into the first arch-like flow channel 24 in the first flow channel end plate 21, the positive electrolyte flows into the at least three hermetically-assembled cell assemblies via the first flow channel aperture 261, and then flows into the second arch-like flow channel 25 via the second flow channel aperture 262. After the negative electrolyte has been injected into the third arch-like flow channel 26 in the second flow channel end plate 22, the negative electrolyte flows into the at least three hermetically-assembled cell assemblies via the second flow channel aperture 263, and then flows into the fourth arch-like flow channel 27 via the fourth flow channel aperture 264.

In a possible embodiment of the present disclosure, the first end plate 11 is provided with a plurality of first via-holes 131, and the second end plate 12 is provided with a plurality of second via-holes 132 corresponding to the first via-holes 131 respectively. Each fastening beam assembly 13 passes through the first via-hole 131 and the corresponding second via-hole 132, so as to fix the first end plate 11, the second end plate 12 and the at least one cell module.

In the embodiments of the present disclosure, the first via-hole is formed at an edge of an end surface of the first end plate 11. The fastening beam assembly 13 is a screw rod with nuts at both ends. The screw rod passes through the first via-hole 131 and the second via-hole 132, and then the nut is screwed in so as to fasten the first end plate 11 and the second end plate 12.

In a possible embodiment of the present disclosure, the flow channel aperture is formed in an end flow channel of each of the first arch-like flow channel 24 and the second arch-like flow channel 25. An end flow channel 241 of the first arch-like flow channel 24 and an end flow channel 251 of the second arch-like flow channel 25 are arranged at upper and lower sides of the first flow channel end plate 21 respectively.

The third arch-like flow channel 26 is arranged opposite to the first arch-like flow channel 24, and the flow channel aperture in the third arch-like flow channel 26 is arranged at a position not opposite to the aperture in the first arch-like flow channel 24. The fourth arch-like flow channel 27 is arranged opposite to the second arch-like flow channel 25, and the flow channel aperture in the fourth arch-like flow channel 27 is arranged at a position not opposite to the flow channel aperture in the second arch-like flow channel 25. An inlet end 242 of the first arch-like flow channel 24 and an inlet end 265 of the third arch-like flow channel 26 are in communication with an external inlet pipe, and an outlet end 252 of the second arch-like flow channel 25 and an outlet end 271 of the fourth arch-like flow channel 27 are in communication with an external outlet pipe. Each of the first arch-like flow channel 24, the second arch-like flow channel 25, the third arch-like flow channel 26 and the fourth arch-like flow channel 27 is provided with a closed end.

In the embodiments of the present disclosure, the first flow channel end plate 21 is of a same structure as the second flow channel end plate 22. In use, after the first flow channel end plate 21 has been fixed, the second flow channel end plate 22 needs to be rotated by 180° to be arranged opposite to the first flow channel end plate 21. After the first end plate 11 is arranged opposite to the second end plate 12, the first flow channel end plate 21 is fixedly coupled to the first end plate 11 through a first positioning pin, and the second flow channel end plate 22 is fixedly coupled to the second end plate 12 through a second positioning pin.

In the embodiments of the present disclosure, the flow channel apertures are formed at the upper and lower sides of the flow channel end plate, so that the electrolyte flows from one side to the other side after it enters the at least three hermetically-assembled cell assemblies. When the flow channel aperture is arranged at a position not opposite to the other flow channel aperture, it means that an orthogonal projection of the first flow channel aperture 261 onto the second flow channel end plate 22 does not overlap with the third flow channel arch-like aperture 263, and an orthogonal projection of the second flow channel aperture 262 onto the second flow channel end plate 22 does not overlap with the fourth flow channel aperture 264, in the case that the second flow channel end plate 22 is rotated by 180° to be arranged opposite to the first flow channel end plate 21, the first arch-like flow channel 24 is arranged opposite to the third arch-like flow channel 26 and the second arch-like flow channel 25 is arranged opposite to the fourth arch-like flow channel 27.

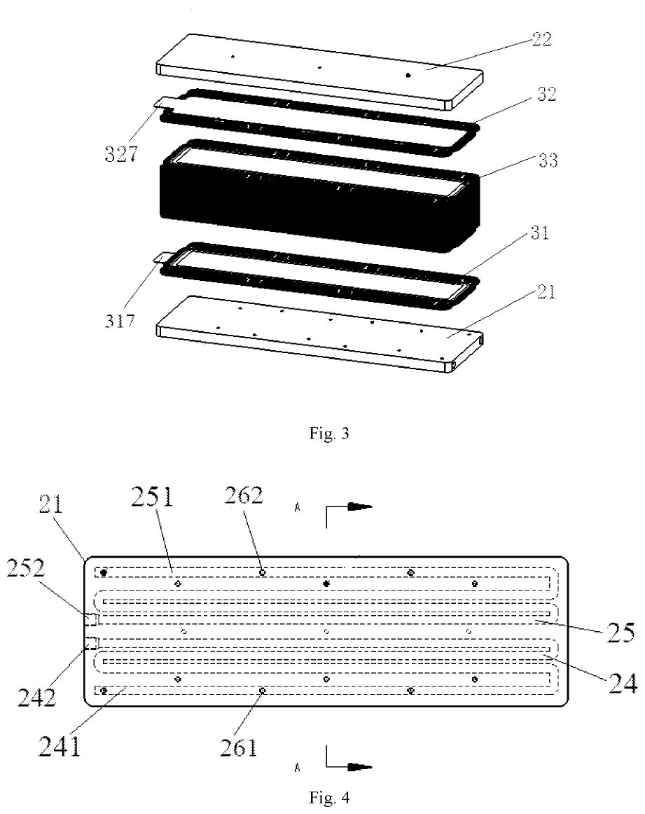

As shown in FIG. 3, in a possible embodiment of the present disclosure, the at least three hermetically-assembled cell assemblies include a first assembly 31, a second assembly 32 hermetically assembled with the first assembly 31, and at least one third assembly 33 arranged between the first assembly 31 and the second assembly 42. The first assembly 31, the second assembly 32 and the at least one third assembly 33 are hermetically assembled. The first assembly is arranged close to, and hermetically assembled with, the first flow channel end plate 21, and the second assembly 32 is arranged closed to, and hermetically assembled with, the second flow channel end plate 22.

In the embodiments of the present disclosure, the first assembly 31 is fixedly coupled to the first flow channel end plate 21, the second assembly 32 is fixedly coupled to the second flow channel end plate 22, and the quantity of third assemblies 33 is determined according to the practical need.

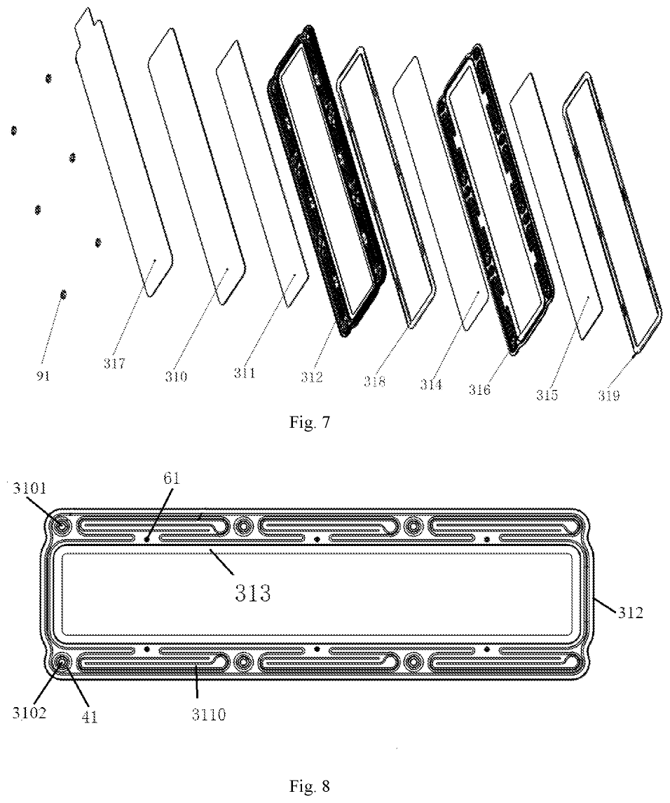

As shown in FIG. 7, in a possible embodiment of the present disclosure, the first assembly 31 includes a first bipolar plate 310, a first electrode 311, a first outer frame 312, a first separator 314, a second electrode 315, a second outer frame 316, a first inner frame 318 and a second inner frame 319. The first outer frame 312 is sleeved onto the first electrode 311, a first installation platform 313 is arranged on a first end surface of the first outer frame 312, and the first bipolar plate 310 is fixed onto the first installation platform 313. The first inner frame 318 is sleeved onto the first electrode 311, and a second end surface of the first inner frame 318 is attached to a second end surface of the first outer frame 312. The first outer frame 312 is assembled with the first inner frame 318, so as to form a plurality of first cavities in communication with the first electrode 311. The first separator 314 is arranged between the first electrode 311 and the second electrode 315, and coupled to the first electrode 311, the second electrode 315, a first end surface of the first inner frame 318 and a first end surface of the second outer frame 316. Each of the second inner frame 319 and the second outer frame 316 is sleeved onto the second electrode 315. A second end surface of the second inner frame 319 is attached to a second end surface of the second outer frame 316. The second outer frame 316 is assembled with the second inner frame 319 so as to form a plurality of second cavities in communication with the second electrode 315.

In the embodiments of the present disclosure, the first bipolar plate 310 is fixedly coupled to the first installation platform 313 through laser welding, a hot-melt film, or an adhesive. Polarity of the first electrode 311 is opposite to polarity of the second electrode 315, i.e., when the first electrode 311 is positive, the second electrode 315 is negative. The first separator 314 is fixedly coupled to the first end surface of the first inner frame 318 and the first end surface of the second outer frame 316 through laser welding, a hot-melt film, or an adhesive, so as to be fixed between the first electrode 311 and the second electrode 315. The first separator 314 is used to separate the electrolyte flowing to the first electrode 311 from the electrolyte flowing to the second electrode 315, thereby to prevent the electrolyte flowing via the first cavity to the first electrode 311 from flowing to the second electrode 315.

Through the first cavity, after the first inner frame 318 is hermetically assembled with the first outer frame 312, the electrolyte at the second end surface of the first outer frame 312 merely flows to the first electrode 311 via the first cavity. Identically, the electrolyte at the second end surface of the second outer frame 316 merely flows to the second electrode 315 via the second cavity.

As shown in FIG. 7, in a possible embodiment of the present disclosure, the first assembly 31 further includes a first current collector 317 in contact with the first bipolar plate 310.

In the embodiments of the present disclosure, the first current collector 317 is a metal foil made of copper for collecting a current. A length of the first current collector 317 needs to be greater than a length of the first outer frame 312, and one end of the first current collector 317 extends through one end of the first outer frame 312 so as to be coupled to an external power source.

In a possible embodiment of the present disclosure, all side walls on the second end surface of the first outer frame 312 and the second end surface of the second outer frame 316 are each of a double-wall structure, and all side walls on the first end surface of the first outer frame 312 and the first end surface of the second outer frame 316 are each of a single-wall structure for the hermetically assembling with the double-wall structure. The first end surface of the first outer frame 312 is fixedly coupled to the first flow channel end plate 21, the second end surface of the first outer frame 312 is fixedly coupled to the first end surface of the second outer frame 316, and the first end surface of the second outer frame 316 is fixedly coupled to the third assembly 33.

In the embodiments of the present disclosure, the double-wall structure refers to that the side wall is of a double-layer structure. Taking the second outer frame 316 as an example, as shown in FIG. 32 which is a sectional view of the second outer frame 316 at a fourth inlet flow channel 3115 and a third inlet flow channel 3113, side walls 93 and 94 at two sides of the fourth inlet flow channel 3115 are each of a double-layer structure consisting of a first side wall 95 and a second side wall 96, and a groove is formed between the first side wall 95 and the second side wall 96, where 90 represents the second end surface of the second outer frame 316, and 99 represents the first end surface of the second outer frame 316.

In FIG. 32, 3113 represents the third inlet flow channel, and 97 and 98 represent side walls at two sides of the third inlet flow channel 3113, and each of the side walls 97 and 98 is of a single-wall structure. The side wall 97 is adapted to the groove between the first side wall 95 and the second side wall 96 for hermetical engagement.

During the assembling, the second end surface of the first outer frame 312 is fixedly coupled to the first end surface of the second outer frame 316 through the single-wall structure on the first end surface of the second outer frame 316 and the double-wall structure on the second end surface of the first outer frame 312. Then, the electrolyte flows to the first electrode 311 via the plurality of first cavities, so that the entire first electrode 311 is immersed in the electrolyte quickly.

Identically, after the second end surface of the second outer frame 316 is fixedly coupled to the third assembly 33, the electrolyte flows to the second electrode 315 via the plurality of second cavities, so that the entire second electrode 315 is immersed in the electrolyte quickly.

In the embodiments of the present disclosure, a first stopping column 61 is arranged on the first end surface of the first outer frame 312, and a first stopping hole 62 is formed in the first flow channel end plate 21. The first outer frame 312 is fixedly coupled to the first flow channel end plate 21 through the first stopping column 61 and the first stopping hole 62.

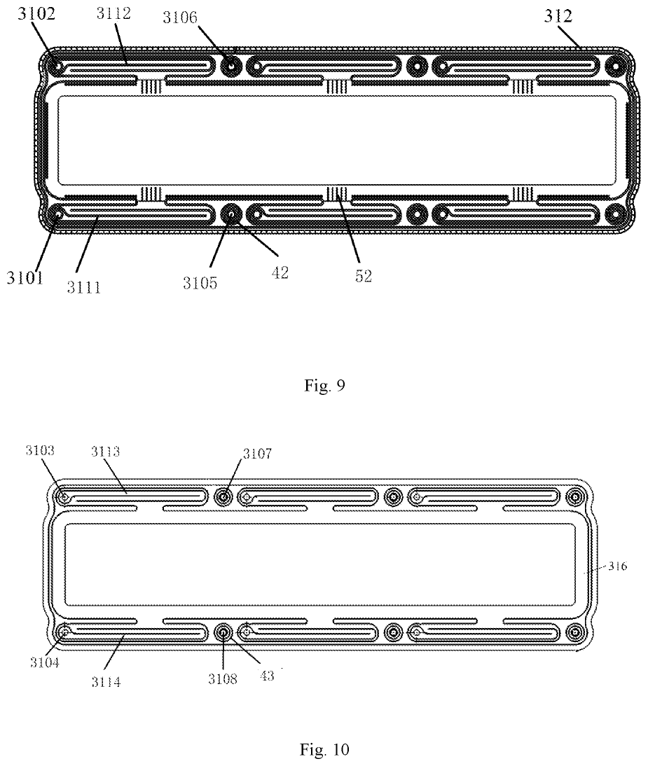

As shown in FIGS. 8 to 11, in a possible embodiment of the present disclosure, the first outer frame 312 is provided with a plurality of first inlets 3101 and a plurality of first outlets 3102, and the second outer frame 316 is provided with a plurality of second inlets 3103 and a plurality of second outlets 3104. Each first inlet 3101 is in communication with a corresponding second inlet 3103, and each first outlet 3102 is in communication with a corresponding second outlet 3104. Each first inlet 3101 is arranged at a position corresponding to, and in communication with, the flow channel aperture in the first arch-like flow channel 24. The first outlet 3102 is arranged at a position corresponding to, and in communication with, the flow channel aperture in the second arch-like flow channel 25.

The second end surface of the first outer frame 312 is provided with a plurality of first electrolyte-intake blocking aperture 3105 and a plurality of first electrolyte-outtake blocking aperture 3106, and the second outer frame 316 is further provided with a plurality of inlets 3107 and a plurality of third outlets 3108. Each third inlet 3107 is in communication with a corresponding first electrolyte-intake blocking aperture 3105, and arranged at a position corresponding to the flow channel aperture in the third arch-like flow channel 26. The third outer 3108 is in communication with the first electrolyte-outtake blocking aperture 3106, and arranged at a position corresponding to the flow channel aperture in the fourth arch-like flow channel 27.

A first annular groove 41 is formed at a periphery of each of the first inlets 3101 and the first outlets 3102 in the first end surface of the first outer frame 312, a second annular groove 42 is formed at a periphery of each of the first electrolyte-intake blocking apertures 3105 and the first electrolyte-outtake blocking apertures 3106, a third annular groove 43 is formed at a periphery of each of the third inlets 3107 and the third outlets 3108 in the first end surface of the second outer frame 316, and a fourth annular groove 44 is formed at a periphery of each of the second inlets 3103 and the second outlets 3104 in the second end surface of the second outer frame 316.

In the embodiments of the present disclosure, side walls of the annular grooves in the second end surface of the first outer frame 312 and the second end surface of the second outer frame 316 are each of a double-wall structure, and side walls of the annular grooves in the first end surface of the first output frame 312 and the first end surface of the second outer frame 316 are each of a single-wall structure. Due to the first annular groove 41, after the first flow channel end plate 21, the first outer frame 312 and the second outer frame 316 are assembled together, the first flow channel aperture 261 is in direct, hermetical communication with the corresponding first inlet 3101, and the second flow channel aperture 262 is in direct, hermetical communication with the corresponding first outlet 3102. At this time, the electrolyte from the first flow channel aperture 261 flows to the second end surface, rather than the first end surface, of the first outer frame 312. Identically, the electrolyte from the first outlet 3102 flows through the second flow channel 262 to the second arch-like flow channel 25 rather than to the first end surface of the first outer frame 312. In addition, during the assembling of the first outer frame 312 with the first flow channel end plate 21, a first gasket 91 is arranged in the first annular groove 41, so as to further prevent the electrolyte from flowing to the first end surface of the first outer frame 312.

In the embodiments of the present disclosure, when the first outer frame 312 is fixedly coupled to the second outer frame 316, the second annular groove 42 and the third annular groove 43 are engaged with each other through the single-wall structure and the double-wall structure so as to form a hermetical communication channel. At this time, the first electrolyte-intake blocking aperture 3105 is in direct, hermetical communication with the third inlet 3107 via the communication channel, and the first electrolyte-outtake blocking aperture 3106 is also in direct, hermetical communication with the third outlet 3108. The first electrolyte-intake blocking aperture 3105 and the first electrolyte-outtake blocking aperture 3106 are each in a blocking state, so the electrolyte entering the third inlet 3107 and the third outlet 3108 flows merely on the second end surface of the second outer frame 316 rather than to any end surface of the first outer frame 312.

In the embodiments of the present disclosure, due to the third annular groove 44, the electrolyte on the second end surface of the second outer frame 316 does not flow through the second inlet 3103 and the second outlet 3104 to the first end surface of the second outer frame 316. In addition, the electrolyte from the first flow channel aperture 261 directly flows through the second inlet 3103 to the third assembly 33 without flowing to the second end surface of the second outer frame 316. Furthermore, the electrolyte in the third assembly 33 flows through the second outlet 3104 to the first end surface of the second outer frame 316 and directly flows through the first outlet 3102 to the second arch-like flow channel 25 without flowing to the second end surface of the second outer frame 316.

In a possible embodiment of the present disclosure, the first end surface of the first outer frame 312 is provided with a plurality of first flow channels 3110, and the second end surface of the first outer frame 312 is provided with a plurality of second inlet flow channels 3111 and a plurality of second outlet flow channels 3112. Each second inlet flow channel 3111 is in communication with one first inlet 3101 and one first cavity, and each second outlet flow channel 3112 is in communication with one first outlet 3102 and one first cavity.

The first end surface of the second outer frame 316 is provided with a plurality of third inlet flow channels 3113 and a plurality of third outlet flow channels 3114, each third inlet flow channel 3113 is in communication with one second inlet 3103, and each third outlet flow channel 3114 is in communication with one second outlet 3104.

The second end surface of the second outer frame 316 is provided with a plurality of fourth inlet flow channels 3115 and a plurality of fourth outlet flow channels 3116, each fourth inlet flow channel 3115 is in communication with one third inlet 3107 and one second cavity, and each fourth outlet flow channel 3116 is in communication with one third outlet 3108 and one second cavity.

In the embodiments of the present disclosure, side walls of the flow channels on the second end surface of the first outer frame 312 and the second end surface of the second outer frame 316 are each of a double-wall structure, and side walls of the flow channels on the first end surface of the first outer frame 312 and the first end surface of the second outer frame 316 are each of a single-wall structure. Each first flow channel 3110 on the first outer frame 312 functions as a support, so as to prevent the first outer frame 312 from being damaged during the fastening. After the first outer frame 312 has been assembled with the second outer frame 316, the second inlet flow channel 3111 is engaged with the corresponding third inlet flow channel 3113 through the single-wall structure and the double-wall structure, so as to form a first hermetical flow channel. At this time, the first inlet 3101 in the second end surface of the first outer frame 312, the second inlet 3103 in the second end surface of the second outer frame 316 and the first cavity are in communication with each other via the first hermetical flow channel, so the electrolyte from the first flow channel aperture 261 directly flows to the first electrode 311 and the second inlet 3103.

Identically, the second outlet flow channel 3112 is engaged with the corresponding third outlet flow channel 3114 to form a second hermetical flow channel. At this time, the first outlet 3102 in the second end surface of the first outer frame 312, the second outlet 3104 in the second end surface of the second outer frame 316 and the first cavity are in communication with each other via the second hermetical flow channel, so the electrolyte from the first electrode 311 merely flows through the first cavity to the first outlet 3102 or the second outlet 3104, and the electrolyte entering the first outlet 3102 directly flows to the second arch-like flow channel 25.

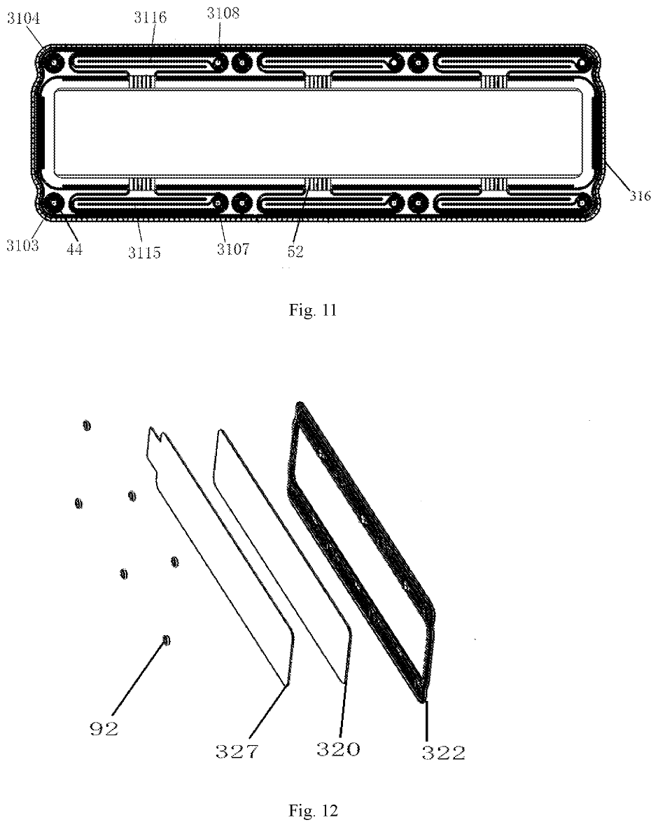

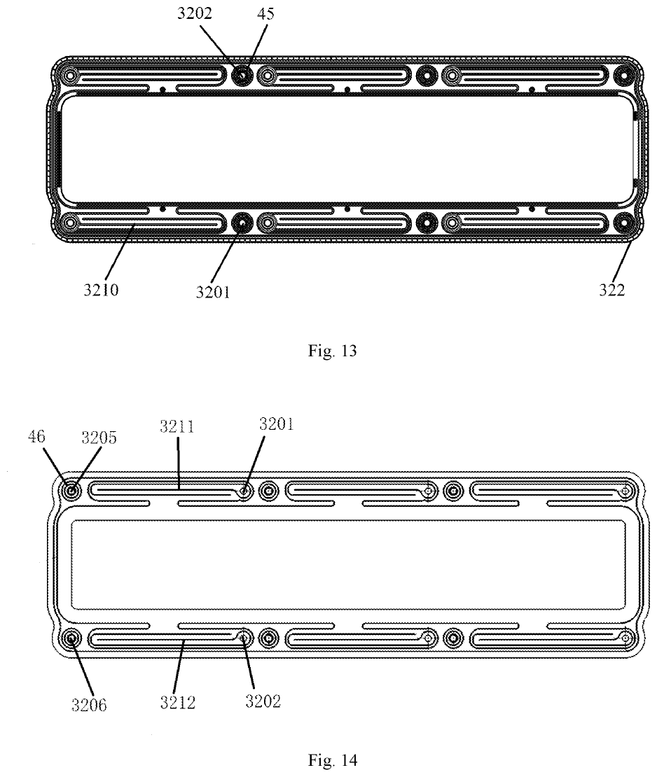

As shown in FIGS. 12 to 14, in a possible embodiment of the present disclosure, the second assembly 32 includes a second bipolar plate 320, a third outer frame 322 sleeved onto the second bipolar plate 320, and a second current collector 327 in contact with the second bipolar plate 320. Side walls on a second end surface of the third outer frame 322 are each of a double-wall structure, and side walls on a first end surface of the third outer frame 322 are each of a single-wall structure adapted to the double-wall structure. The second end surface of the third outer frame 322 is fixedly coupled to the second flow channel end plate 22, and the first end surface of the third outer frame 322 is fixedly coupled to the third assembly 33.

In the embodiments of the present disclosure, the second current collector 327 is a metal foil for collecting a current, and it is arranged between the second end surface of the third outer frame 322 and the second flow channel end plate 22. A length of the second current collector 327 needs to be greater than a length of the third outer frame 322, and one end of the second current collector 327 extends through one end of the third outer frame 322 so as to be coupled to an external power source.

In the embodiments of the present disclosure, a second stopping column 63 is arranged on the second end surface of the third outer frame 322, and a corresponding second stopping hole is formed in the second flow channel end plate 22. The third outer frame 322 is fixedly coupled to the second flow channel end plate 22 through the second stopping column 63 and the second stopping hole.

In a possible embodiment of the present disclosure, the third outer frame 322 is provided with a plurality of fourth inlets 3201 and a plurality of fourth outlets 3202, and the first end surface of the third outer frame 322 is provided with a plurality of second electrolyte-intake blocking apertures 3205 and a plurality of second electrolyte-outtake blocking apertures 3206. Each fourth inlet 3201 is arranged at a position corresponding to, and in communication with, the flow channel aperture in the third arch-like flow channel 26, and each fourth outlet 3202 is arranged at a position corresponding to, and in communication with, the flow channel aperture in the fourth arch-like flow channel 27. The second electrolyte-intake blocking aperture 3205 is arranged at a position corresponding to the flow channel aperture in the first arch-like flow channel 24, and the second electrolyte-outtake blocking aperture 3206 is arranged at a position corresponding to the flow channel aperture in the second arch-like flow channel 25. A fifth annular groove 45 is formed at a periphery of each of the fourth inlets 3201 and the fourth outlets 3202 in the second end surface of the third outer frame 322, and a sixth annular groove 46 is formed at a periphery of each of the second electrolyte-intake blocking apertures 3205 and the second electrolyte-outtake blocking apertures 3206 in the first end surface of the third outer frame 322.

In the embodiments of the present disclosure, through the fifth annular groove 45 in the second end surface of the third outer frame 322, the third flow channel aperture 263 is in direct, hermetical communication with the fourth inlet 3201, and the fourth flow channel aperture 264 is in direct, hermetical communication with the fourth outlet 3202. At this time, the electrolyte from the third flow channel aperture 263 directly flows to the first end surface of the third outer frame 322 rather than to the second end surface of the third outer frame 322. Identically, the electrolyte from the fourth outlet 3202 directly flows through the fourth flow channel aperture 264 to the fourth arch-like flow channel 27 rather than to the second end surface of the third outer frame 322. In addition, during the assembling of the third outer frame 322 with the second flow channel end plate 22, a second gasket 92 is provided in the fifth annular groove 45 in the second end surface of the third outer frame 322, so as to further prevent the electrolyte from flowing to the second end surface of the third outer frame 312.

In the embodiments of the present disclosure, side walls of the annular grooves in the first end surface of the third outer frame 322 are each of a single-wall structure. Due to the second electrolyte-intake blocking aperture 3205, the second electrolyte-outtake blocking aperture 3206 and the sixth annular groove 46, after the third outer frame 322 has been assembled with the third assembly 33, the second electrolyte-intake blocking aperture 3205 and the second electrolyte-outtake blocking aperture 3206 are in direct communication with the third assembly 33. In addition, due to the blocking at the bottom, the electrolyte flowing from the third assembly 33 into the sixth annular groove 46 does not flow to any end surface of the outer frame 322.

In a possible embodiment of the present disclosure, the second end surface of the third outer frame 322 is provided with a plurality of fifth flow channels 3210, the first end surface of the third outer frame 322 is provided with a plurality of sixth inlet flow channels 3211 and a plurality of sixth outlet flow channels 3212, each sixth inlet flow channel 3211 is in communication with one fourth inlet 3201, and each sixth outlet flow channel is in communication with one fourth outlet 3202.

In the embodiments of the present disclosure, side walls of the flow channels on the first end surface of the third outer frame 322 are each of a double-wall structure. The fifth flow channel 3210 on the third outer frame 322 functions as a support, so as to prevent the third outer frame 322 from being damaged during the fastening. Due to the sixth inlet flow channel 3211, the electrolyte from the third flow channel aperture 263 merely flows to the third assembly 33, and due to the sixth outlet flow channel 3212, the electrolyte in the sixth outlet flow channel 3212 merely flows through the fourth outlet 3202 to the fourth flow channel aperture 264.

As shown in FIG. 15, in a possible embodiment of the present disclosure, the third assembly 33 includes a fourth bipolar plate 330, a fifth electrode 331, a fifth outer frame 332, a third separator 334, a sixth electrode 335, a sixth outer frame 336, a fifth inner frame 338 and a sixth inner frame 339. The fifth outer frame 332 is sleeved onto the fifth electrode 331, a first end surface of the fifth outer frame 332 is provided with a third installation platform 333, and the fourth bipolar plate 330 is fixed on the third installation platform 333. The fifth inner frame 338 is sleeved onto the fifth electrode 331, and the second end surface of the fifth inner frame 338 is attached to the second end surface of the fifth outer frame 332. The fifth outer frame 332 is assembled with the fifth inner frame 338 to form a plurality of fourth cavities in communication with the fifth electrode 331. The third separator 334 is arranged between the fifth electrode 331 and the sixth electrode 335, and coupled to the fifth electrode 331, the sixth electrode 335, the first end surface of the fifth inner frame 338 and a first end surface of the sixth outer frame 336. Each of the fifth inner frame 339 and the sixth outer frame 336 is sleeved onto the sixth electrode 335. A second end surface of the sixth inner frame 339 is attached to a second end surface of the sixth outer frame 336, and the sixth outer frame 336 is assembled with the sixth inner frame 339 to form a plurality of fifth cavities in communication with the sixth electrode 335.

In the embodiments of the present disclosure, one or more third assemblies 33 is provided. In the case of a plurality of third assemblies 33, the first end surface of the fifth outer frame 332 of the current third assembly 33 is attached to the second end surface of the sixth outer frame 336 of the previous third assembly 33.

The fourth bipolar plate 330 is fixedly coupled to the third installation platform 333 through laser welding, a hot-melt film, or an adhesive. Polarity of the fifth electrode 331 is opposite to polarity of the sixth electrode 335, and identical to the polarity of the first electrode 331. The third separator 334 is fixedly coupled to the first end surface of the fifth inner frame 338 and the sixth end surface of the second outer frame 336 through laser welding, a hot-melt film, or an adhesive, so as to be fixed between the fifth electrode 331 and the sixth electrode 335. The third separator 334 is used to separate the electrolyte flowing to the fifth electrode 331 from the electrolyte flowing to the sixth electrode 335, thereby to prevent the electrolyte flowing via the fourth cavity to the fifth electrode 331 from flowing to the sixth electrode 335.

Through the fourth cavity, after the fifth inner frame 338 is hermetically assembled with the fifth outer frame 332, the electrolyte at the second end surface of the fifth outer frame 332 merely flows to the fifth electrode 331 via the fourth cavity. Identically, the electrolyte at the second end surface of the sixth outer frame 336 merely flows to the sixth electrode 335 via the fifth cavity.

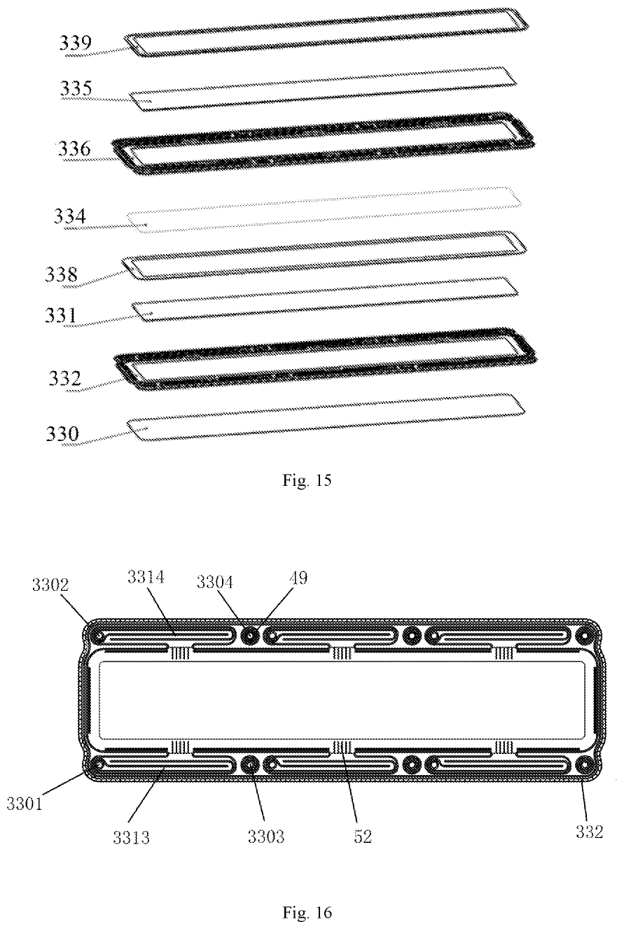

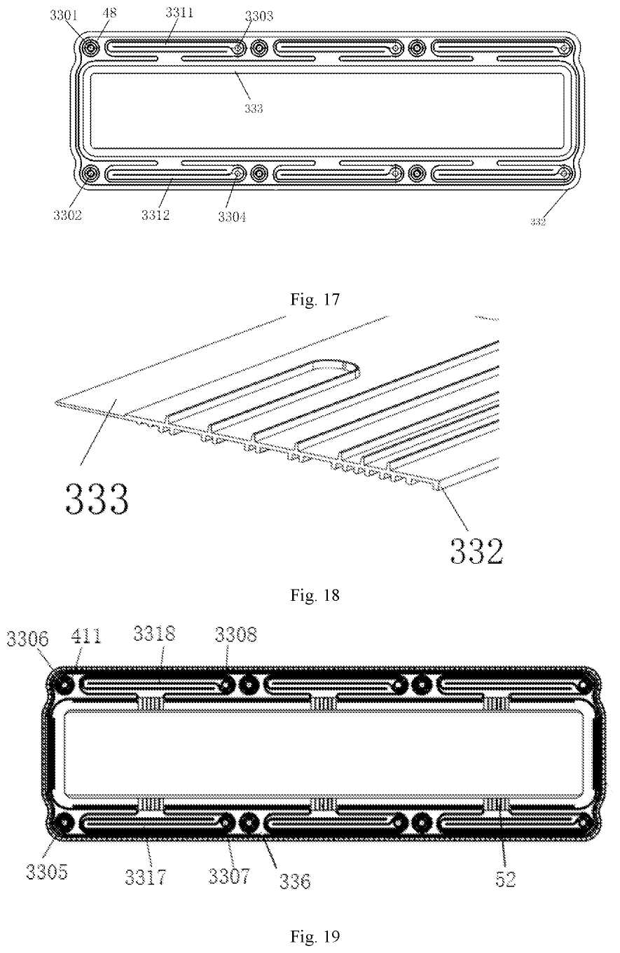

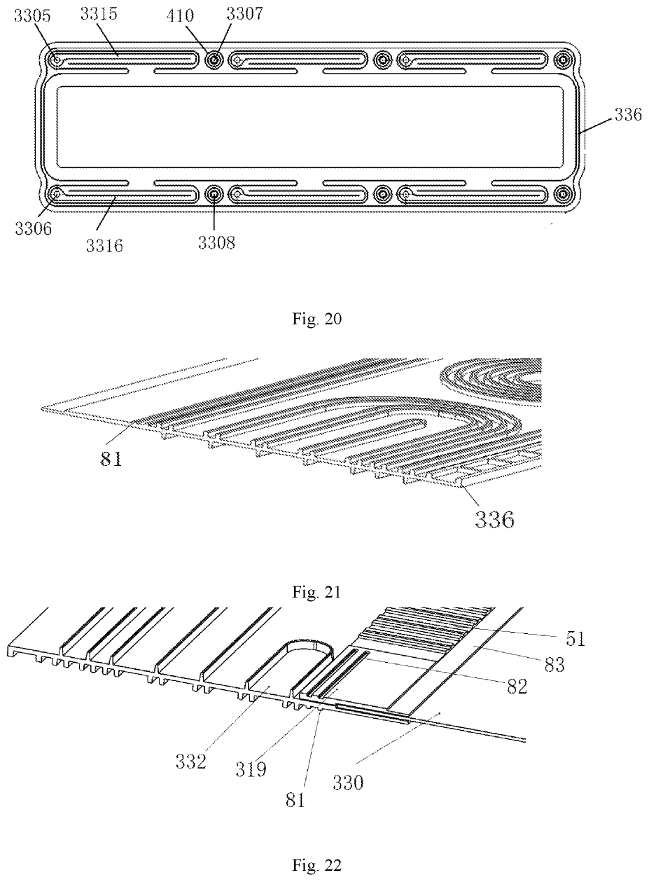

As shown in FIGS. 16 to 21, in a possible embodiment of the present disclosure, side walls on the second end surface of the fifth outer frame 332 and the second end surface of the sixth outer frame 336 are each of a double-wall structure, and side walls on the first end surface of the fifth outer frame 332 and the first end surface of the sixth outer frame 336 are each of a single-wall structure adapted to the double-wall structure. The second end surface of the fifth outer frame 332 is fixedly coupled to the first end surface of the sixth outer frame 336, the first end surface of the fifth outer frame 332 is fixedly coupled to the second end surface of the second outer frame 316, and the second end surface of the sixth outer frame 336 is fixedly coupled to the first end surface of the third outer frame 322.

In the embodiments of the present disclosure, during the assembling of the cell stack of the flow battery, the second end surface of the sixth outer frame 336 is engaged with the first end surface of the third outer frame 322 through the single-wall structure and the double-wall structure. The first end surface of the sixth inner frame 339 is fixedly coupled to the second bipolar plate through laser welding, a hot-melt film or an adhesive. The second end surface of the fifth outer frame 332 is engaged with the first end surface of the sixth outer frame 336 through the single-wall structure and the double-wall structure, and the first end surface of the fifth outer frame 332 is engaged with the second end surface of the second outer frame 316 through the single-wall structure and the double-wall structure.

Identically, after the first end surface of the fifth outer frame 332 has been fixedly coupled to the second end surface of the second outer frame 316, the electrolyte on the second end surface of the second outer frame 316 flows to the fifth electrode 331 via the plurality of fourth cavities, so that the entire fifth electrode 331 is immersed in the electrolyte quickly.

Identically, after the second end surface of the sixth outer frame 336 has been fixedly coupled to the first end surface of the third outer frame 322, the electrolyte on the second end surface of the sixth outer frame 336 flows to the sixth electrode 335 via the plurality of fifth cavities, so that the entire sixth electrode 335 is immersed in the electrolyte quickly.

In a possible embodiment of the present disclosure, the fifth outer frame 332 is provided with a plurality of seventh inlets 3301, a plurality of seventh outlets 3302, a plurality of eighth inlets 3303 and a plurality of eighth outlets 3304. Each seventh inlet 3301 is arranged at a position corresponding to the flow channel aperture in the first arch-like flow channel 24, each seventh outlet 3302 is arranged at a position corresponding to the flow channel aperture in the second arch-like flow channel 25, each eighth inlet 3303 is arranged at a position corresponding to the flow channel aperture in the third arch-like flow channel 26, and each eighth outlet 3304 is arranged at a position corresponding to the flow channel aperture in the fourth arch-like flow channel 27.

The sixth outer frame 336 is provided with a ninth inlet 3305 arranged at a position corresponding to, and in communication with, the seventh inlet 3301, a ninth outlet 3306 arranged at a position corresponding to, and in communication with, the seventh outlet 3302, a tenth inlet 3307 arranged at a position corresponding to, and in communication with, the eighth inlet 3303, and a tenth outlet 3308 arranged at a position corresponding to, and in communication with, the eighth outlet 3304.

An eighth annular groove 48 is formed at a periphery of each of the seventh inlets 3301 and the seventh outlets 3302 in the first end surface of the fifth outer frame 332, a ninth annular groove 49 is formed at a periphery of each of the eighth inlets 3303 and the eighth outlets 3304 in the second end surface of the fifth outer frame 332, a tenth annular groove 410 is formed at a periphery of each of the tenth inlets 3307 and the tenth outlets 3308 in the first end surface of the sixth outer frame 336, and an eleventh annular groove 411 is formed at a periphery of each of the ninth inlets 3305 and the ninth outlets 3306 in the second end surface of the sixth outer frame 336.

In the embodiments of the present disclosure, side walls of the annular grooves in the second end surface of the fifth outer frame 332 and the second end surface of the sixth outer frame 336 are ach of a double-wall structure, and side walls of the annular grooves in the first end surface of the fifth outer frame 332 and the first end surface of the sixth outer frame 336 are each of a single-wall structure. After the assembling, due to the ninth annular groove 49 in the second end surface of the fifth outer frame 332 and the tenth annular groove 410 in the first end surface of the sixth outer frame 336, the eighth inlet 3303 is in direct, hermetical communication with the tenth inlet 3307, and the eighth outlet 3304 is in direct, hermetical communication with the tenth outlet 3308. At this time, the electrolyte on the second end surface of the sixth outer frame 336 directly flows to the first end surface of the fifth outer frame 332 rather than to the second end surface of the fifth outer frame 332 through the tenth inlet 3307 and the tenth outlet 3308.

Due to the eighth annular groove 48 in the first end surface of the fifth outer frame 332 and the fourth annular groove 44 in the second end surface of the second outer frame 316, the second inlet 3103 is in direct, hermetical communication with the seventh inlet 3301, and the second outlet 3104 is in direct, hermetical communication with the seventh outlet 3302. At this time, the electrolyte on the first end surface of the fifth outer frame 332 directly flows to the second end surface of the second outer frame 316, rather than to the first end surface of the second outer frame 316 through the seventh inlet 3301 and the seventh outlet 3302, or to the first end surface of the second outer frame 316 through the third inlet 3107 and the third outlet 3108 due to the first electrolyte-intake blocking aperture 3105 and the first electrolyte-outtake blocking aperture 3106.

Due to the eleventh annular groove 411 in the second end surface of the sixth outer frame 336 and the sixth annular groove 46 in the first end surface of the third outer frame 322, the ninth inlet 3305 is in direct, hermetical communication with the second electrolyte-intake blocking aperture 3205, and the ninth outlet 3306 is in direct, hermetical communication with the second electrolyte-outtake blocking aperture 3206. At this time, the electrolyte flows merely on the second end surface of the fifth outer frame 332, rather than to the second end surface of the sixth outer frame 336 through the ninth inlet 3305 and the ninth outlet 3306.

In the embodiments of the present disclosure, after the assembling of the cell stack of the flow battery, the first flow channel aperture 261 is in communication with the first inlet 3101, the second inlet 3103, the seventh inlet 3301, the ninth inlet 3305 and the second electrolyte-intake blocking aperture 3205.

The second channel aperture 262 is in communication with the first outlet 3102, the second outlet 3104, the seventh outlet 3302, the ninth outlet 3306 and the second electrolyte-outtake blocking aperture 3206. The second electrolyte-intake blocking aperture 3205 and the second electrolyte-outtake blocking aperture 3206 are used to block the electrolyte on the second end surface of the fifth outer frame 332 from flowing to the second end surface of the sixth outer frame 336, and merely allow the electrolyte to flow through the seventh outlet 3302 into the second arch-like flow channel 25.

The third flow channel aperture 263 is in communication with the fourth inlet 3201, the tenth inlet 3307, the eighth inlet 3303, the third inlet 3107 and the first electrolyte-intake blocking aperture 3105.

The fourth channel aperture 264 is in communication with the fourth outlet 3202, the tenth outlet 3308, the eighth outlet 3304, the third outlet 3108 and the first electrolyte-outtake blocking aperture 3106. The first electrolyte-intake blocking aperture 3105 and the first electrolyte-outtake blocking aperture 3106 are mainly used to block the third inlet 3107 and the third outlet 3108 in the first end surface of the second outer frame 316, so as to prevent the electrolyte on the second end surface of the second outer frame 316 from flowing to the first end surface of the second outer frame 316, and merely allow the electrolyte to flow through the third outlet 3108 into the fourth arch-like flow channel 27.

In a possible embodiment of the present disclosure, the first end surface of the fifth outer frame 332 is provided with a plurality of ninth inlet flow channels 3311 and a plurality of ninth outlet flow channels 3312, each ninth inlet flow channel 3311 is in communication with one eighth inlet 3303, and each ninth outlet flow channel 3312 is in communication with one eighth outlet 3304. The second end surface of the fifth outer frame 332 is provided with a plurality of tenth inlet flow channels 3313 and a plurality of tenth outlet flow channels 3314, each tenth inlet flow channel 3313 is in communication with one seventh inlet 3301 and one fourth cavity, and each tenth outlet flow channel 3314 is in communication with one seventh outlet 3302 and one fourth cavity.

The first end surface of the sixth outer frame 336 is provided with a plurality of eleventh inlet flow channels 3315 and a plurality of eleventh outlet flow channels 3316, each eleventh inlet flow channel 3315 is in communication with one ninth inlet 3305, and each eleventh outlet flow channel 3316 is in communication with one ninth outlet 3306. The second end surface of the sixth outer frame 336 is provided with a plurality of twelfth inlet flow channels 3317 and a plurality of twelfth outlet flow channels 3318, each twelfth inlet flow channel 3317 is in communication with one tenth inlet 3307 and one fifth cavity, and each twelfth outlet flow channel 3318 is in communication with one tenth outlet 3308 and one fifth cavity.

In the embodiments of the present disclosure, side walls of the flow channels on the second end surface of the fifth outer frame 332 and the second end surface of the sixth outer frame 336 are each of a double-wall structure, and side walls of the flow channels on the first end surface of the fifth outer frame 332 and the first end surface of the sixth outer frame 336 are each of a single-wall structure. During the assembling of the sixth outer frame 336 with the third outer frame 322, the twelfth inlet flow channel 3317 is engaged with the sixth inlet flow channel 3211 through the single-wall structure and the double-wall structure, so as to form a third hermetical flow channel. At this time, the tenth inlet 3307 in the second end surface of the sixth outer frame 336, the fourth inlet flow channel 3201 in the first end surface of the third outer frame 326 and fifth cavity in communication with the twelfth inlet flow channel 3317 are in communication with each other via the third hermetical flow channel, so the electrolyte from the third flow channel aperture 263 merely flows through the third hermetical flow channel to the tenth inlet 3307 and the sixth electrode 335.

Identically, the twelfth outlet flow channel 3318 is engaged with the sixth outlet flow channel 3212 to form a fourth hermetical flow channel. At this time, the tenth outlet 3308 in the second end surface of the sixth outer frame 336, the fourth outlet flow channel 3202 in the first end surface of the third outer frame 322 and the fifth cavity in communication with the twelfth outlet flow channel 3318 are in communication with each other via the fourth hermetical flow channel, so the electrolyte in the fourth hermetical flow channel merely flows into the tenth outlet 3308 and the fourth outlet flow channel 3202, and the electrolyte in the fourth outlet flow channel 3202 directly flows through the fourth flow channel aperture 364 into the fourth arch-like flow channel 27.

Identically, after the fifth outer frame 322 has been assembled with the second outer frame 316, the fifth inlet flow channel 3311 is engaged with the fourth inlet flow channel 3115 to form a fifth hermetical flow channel. At this time, the third inlet 3107 in the second end surface of the second outer frame 316, the eighth inlet 3303 in the first end surface of the fifth outer frame 322 and the second cavity in communication with the fourth inlet flow channel 3115 are in communication with each other via the fifth hermetical flow channel, so the electrolyte flowing into the fifth hermetical flow channel through the eighth inlet 3303 merely flows to the third inlet 3107 and the second electrode 315, and the electrolyte in the third inlet 3107 does not flow due to the first electrolyte-intake blocking aperture 3105.

Identically, the ninth outlet flow channel 3312 is engaged with the fourth outlet flow channel 3116 to form a sixth hermetical flow channel. At this time, the third outlet 3108 in the second end surface of the second outer frame 316, the eighth outlet 3304 in the first end surface of the fifth outer frame 322 and the second cavity in communication with the fourth outlet flow channel 3116 are in communication with each other via the sixth hermetical flow channel, so the electrolyte flowing from the second electrode 315 into the sixth hermetical flow channel merely flows into the third outlet 3108 and the eighth outlet 3304, the electrolyte in the third outlet 3108 does not flow due to the first electrolyte-outtake blocking aperture 3106, and the electrolyte in the eighth outlet 3304 directly flows through the fourth flow channel aperture 264 into the second arch-like flow channel 27.

Identically, after the assembling of the fifth outer frame 332 with the sixth outer frame 336, the tenth inlet flow channel 3313 is engaged with the eleventh inlet flow channel 3315 to form a seventh hermetical flow channel. At this time, the seventh inlet 3301 in the second end surface of the fifth outer frame 332, the ninth inlet 3305 in the first end surface of the sixth outer frame 336 and the fourth cavity in communication with the tenth inlet flow channel 3313 are in communication with each other via the seventh hermetical flow channel, so the electrolyte flowing through the seventh inlet 3301 into the seventh hermetical flow channel merely flows to the ninth inlet 3305 and the fifth electrode 331, and the electrolyte in the ninth inlet 3305 does not flow due to the second electrolyte-intake blocking aperture 3205.

Identically, the tenth outlet flow channel 3314 is engaged with the eleventh outlet flow channel 3316 to form an eighth hermetical flow channel. At this time, the seventh outlet 3302 in the second end surface of the fifth outer frame 332, the ninth outlet 3306 in the first end surface of the sixth outer frame 336 and the fourth cavity in communication with the tenth outlet flow channel 3313 are in communication with each other via the eighth hermetical flow channel, so the electrolyte flowing from the fifth electrode 331 into the eighth hermetical flow channel merely flows into the ninth outlet 3306 and the seventh outlet 3302, the electrolyte in the ninth outlet 3306 does not flow due to the second electrolyte-outtake blocking aperture 3206, and the electrolyte in the seventh outlet 3302 directly flows through the second flow channel aperture 262 into the second arch-like flow channel 25.

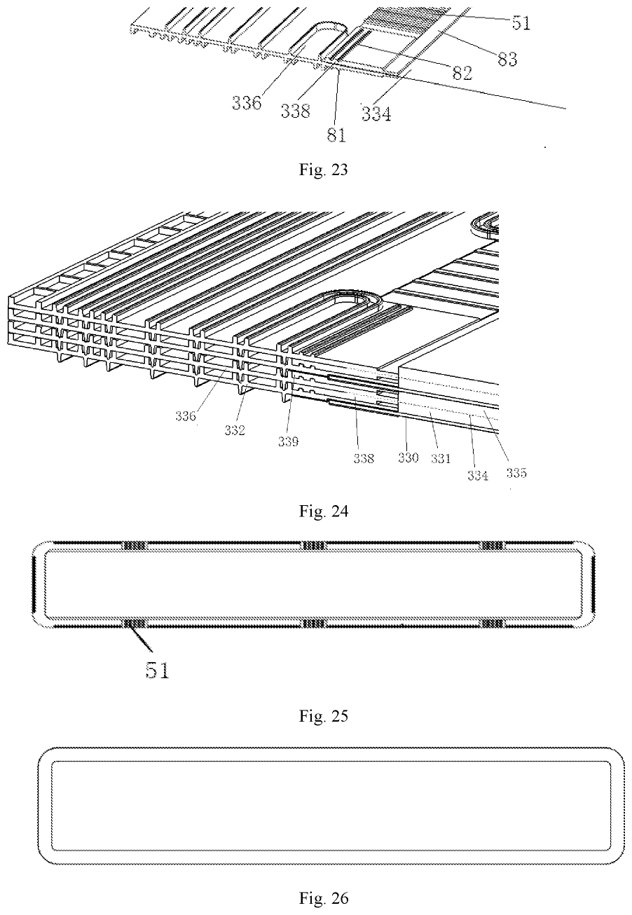

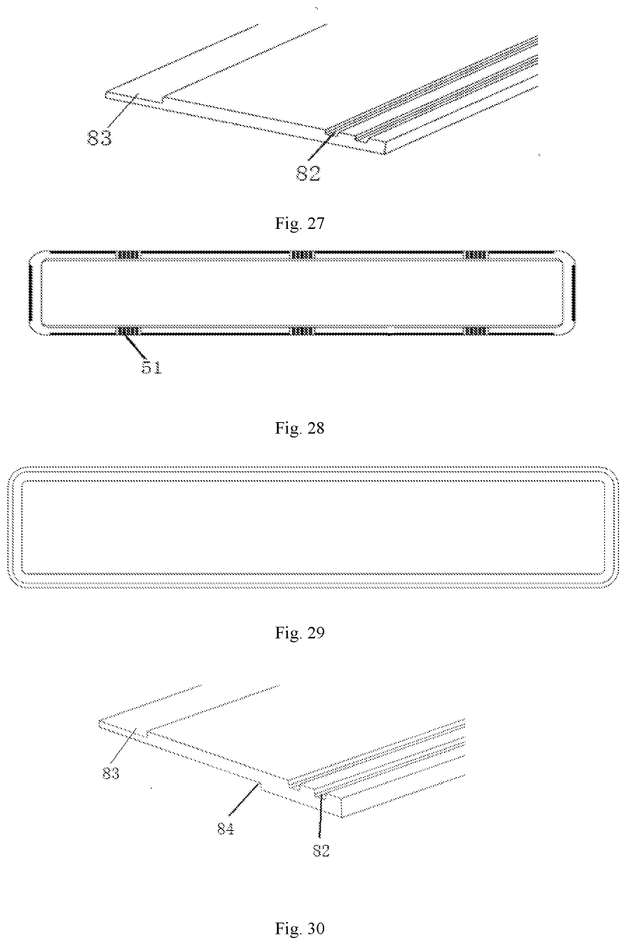

As shown in FIGS. 22 to 31, in a possible embodiment of the present disclosure, each of the first cavity, the second cavity, the fourth cavity and the fifth cavity includes a first groove 51 and a second groove 52. The first groove is formed in each of the second end surface of the first inner frame 318, the second end surface of the second inner frame 319, the second end surface of the fifth inner frame 338 and the second end surface of the sixth inner frame 339, and the second groove 52 matching the first groove 51 is formed in each of the second end surface of the first outer frame 312, the second end surface of the second outer frame 316, the second end surface of the fifth outer frame 332 and the second end surface of the sixth outer frame 336.

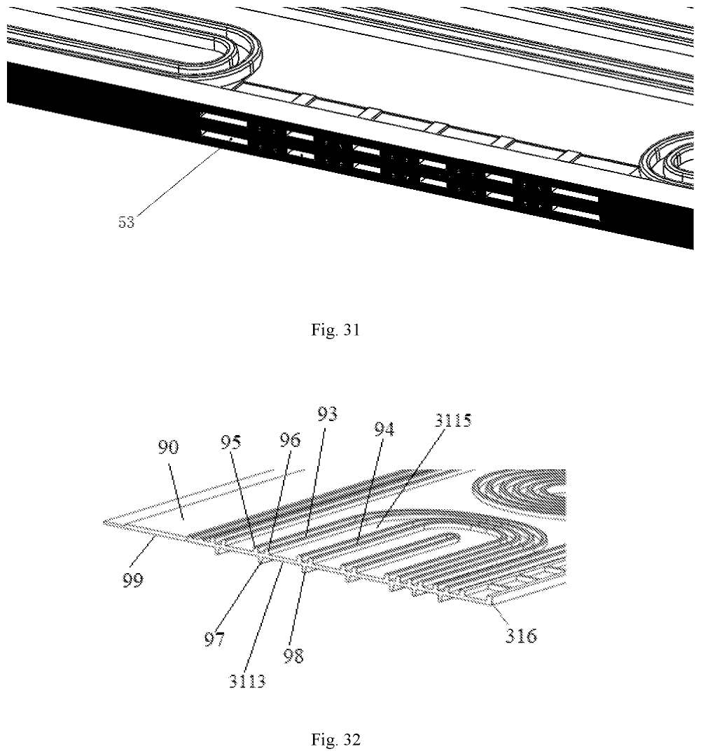

In the embodiments of the present disclosure, each of the first cavity, the second cavity, the fourth cavity and the fifth cavity is formed through the first groove 51 and the second groove 52. In FIG. 31, 53 represents the cavity formed through the first groove 51 and the second groove 52, and the cavity is in communication with the electrode, so that the electrolyte flows via the cavity to the electrode.

In the embodiments of the present disclosure, the first inner frame 318 is of a completely same structure as the fifth inner frame 338, the sixth inner frame 339 is of a completely same structure as the second inner frame 319, and a groove 84 for fixing the bipolar plate is formed in each of the first end surface of the sixth inner frame 339 and the first end surface of the second inner frame 319.

In a possible embodiment of the present disclosure, the inner frames and the outer frames are made of polypropylene, and the flow channel end plates are made of polyvinyl chloride. A first stopping groove 82 is further formed in the second end surface of each inner frame, and a first stopping rib 81 is formed on the second end surface of each outer frame. The outer frame is assembled with the corresponding outer frame through the engagement of the first stopping groove 82 with the first stopping rib 81, so as to prevent the displacement of the inner frame and the outer frame. Each inner frame is further provided with a buffer table 83 between the cavity and the electrode, so as to reduce a flow rate of the electrolyte from the cavity, thereby to reduce an impact on the electrode.

A specific working principle of the cell stack of the flow battery will be described hereinafter. When the first electrode 311 is positive, the fifth electrode 331 is positive too, and the second electrode 315 and the sixth electrode 335 are negative. At this time, the positive electrolyte is injected into the first arch-like flow channel 24, and the negative electrolyte is injected into the third arch-like flow channel 26. After the positive electrolyte from the first flow channel aperture 261 flows to the second end surface of the first outer frame 312 and the second end surface of the fifth outer frame 332 through the first inlet 3101 and the seventh inlet 3301 respectively, and flows to the first electrode 311 and the fifth electrode 331 through the first hermetical flow channel and the seventh hermetical flow channel respectively. Next, the positive electrolyte flows into the second hermetical flow channel and the eighth hermetical flow channel, and flows to the second arch-like flow channel 25 through the first outlet 3102 and the seventh outlet 3302.

In addition, the negative electrolyte from the third flow channel aperture 263 merely flows to the second end surface of the sixth outer frame 336 and the second end surface of the second outer frame 316 through the fourth inlet 3201 and the eighth inlet 3303 respectively, and flows to the sixth electrode 335 and the second electrode 315 through the third hermetical flow channel and the fifth hermetical flow channel respectively. Next, the negative electrolyte flows into the fourth hermetical flow channel and the sixth hermetical flow channel, and then flows into the fourth arch-like flow channel 27 through the fourth outlet 3202 and the eighth outlet 3304.

The second electrode 315 and the sixth electrode 335 are immersed in the electrolyte, and then the electrolyte flows into the fourth arch-like flow channel 27 through the tenth outlet 3308 and the third outlet 3108.

According to the cell stack of the flow battery in the embodiments of the present disclosure, the electrolyte flows to the electrode at a large flow through increasing the quantity of the inlet flow channels and the outlet flow channels in the case that the electrode is too long. As a result, in the case of same power and a same area of the electrode, it is able to reduce a flow resistance of the electrolyte through increasing a length of the electrode and decreasing a width of the electrode, and reduce the power consumption of a pump, thereby to increase the electric energy conversion efficiency.

The present disclosure further provides in some embodiments a flow battery which includes at least one of the above-mentioned cell stack.

According to the flow battery in the embodiments of the present disclosure, it is able to increase the power through a plurality of cell stacks, thereby to meet the requirement on the large power.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A cell stack of a flow battery, comprising: a first end plate; a second end plate; and at least one cell module arranged between the first end plate and the second end plate,
wherein each cell module comprises a first flow channel end plate, a second flow channel end plate arranged opposite to the first flow channel end plate, and single-cell assemblies arranged between the first flow channel end plate and the second flow channel end plate,
wherein the single-cell assemblies comprise at least three hermetically-assembled cell assemblies, the first flow channel end plate is provided with a first arch-like flow channel and a second arch-like flow channel;
the second flow channel end plate is provided with a third arch-like flow channel and a fourth arch-like flow channel;
each of the first arch-like flow channel, the second arch-like flow channel, the third arch-like flow channel and the fourth arch-like flow channel is provided with a flow channel aperture;
each flow channel aperture is in communication with the at least three hermetically-assembled cell assemblies;
an electrolyte in the first arch-like flow channel flows through the at least three hermetically-assembled cell assemblies via the flow channel aperture in the first arch-like flow channel to the second arch-like flow channel; and
an electrolyte in the third arch-like flow channel flows through the at least three hermetically-assembled cell assemblies via the flow channel aperture in the third arch-like flow channel to the fourth arch-like flow channel.

2. The cell stack according to claim 1, wherein the flow channel aperture is formed in an end flow channel of each of the first arch-like flow channel, the second arch-like flow channel, the third arch-like flow channel and the fourth arch-like flow channel;
an end flow channel of the first arch-like flow channel and an end flow channel of the second arch-like flow channel are arranged at upper and lower sides of the first flow channel end plate respectively;
the third arch-like flow channel is arranged opposite to the first arch-like flow channel, and the flow channel aperture in the third arch-like flow channel is arranged at a position not opposite to the aperture in the first arch-like flow channel;
the fourth arch-like flow channel is arranged opposite to the second arch-like flow channel, and the flow channel aperture in the fourth arch-like flow channel is arranged at a position not opposite to the flow channel aperture in the second arch-like flow channel;
an inlet end of the first arch-like flow channel and an inlet end of the third arch-like flow channel are in communication with an external inlet pipe;
an outlet end of the second arch-like flow channel and an outlet end of the fourth arch-like flow channel are in communication with an external outlet pipe; and
each of the first arch-like flow channel, the second arch-like flow channel, the third arch-like flow channel and the fourth arch-like flow channel is provided with a closed end.

3. The cell stack according to claim 1, wherein the at least three hermetically-assembled cell assemblies comprise a first assembly, a second assembly hermetically assembled with the first assembly, and at least one third assembly arranged between the first assembly and the second assembly;
the first assembly, the second assembly and the at least one third assembly are hermetically assembled; and
the first assembly is arranged close to, and hermetically assembled with, the first flow channel end plate, and the second assembly is arranged closed to, and hermetically assembled with, the second flow channel end plate.

4. The cell stack according to claim 3, wherein the first assembly comprises a first bipolar plate, a first electrode, a first outer frame, a first separator, a second electrode, a second outer frame, a first inner frame and a second inner frame;
the first outer frame is sleeved onto the first electrode, a first installation platform is arranged on a first end surface of the first outer frame, and the first bipolar plate is fixed onto the first installation platform;
the first inner frame is sleeved onto the first electrode, and a second end surface of the first inner frame is attached to a second end surface of the first outer frame;
the first outer frame is assembled with the first inner frame, so as to form a plurality of first cavities in communication with the first electrode;
the first separator is arranged between the first electrode 311 and the second electrode, and coupled to the first electrode, the second electrode, a first end surface of the first inner frame and a first end surface of the second outer frame;
each of the second inner frame and the second outer frame is sleeved onto the second electrode;
a second end surface of the second inner frame is attached to a second end surface of the second outer frame;
the second outer frame is assembled with the second inner frame so as to form a plurality of second cavities in communication with the second electrode; and
the first end surface of the first outer frame is fixedly coupled to the first flow channel end plate, the second end surface of the first outer frame is fixedly coupled to the first end surface of the second outer frame, and the first end surface of the second outer frame is fixedly coupled to the third assembly.

5. The cell stack according to claim 4, wherein the first outer frame is provided with a plurality of first inlets and a plurality of first outlets, and the second outer frame is provided with a plurality of second inlets and a plurality of second outlets;
each first inlet is in communication with a corresponding second inlet, and each first outlet is in communication with a corresponding second outlet;
each first inlet is arranged at a position corresponding to, and in communication with, the flow channel aperture in the first arch-like flow channel;
the first outlet is arranged at a position corresponding to, and in communication with, the flow channel aperture in the second arch-like flow channel;
the second end surface of the first outer frame is provided with a plurality of first electrolyte-intake blocking aperture and a plurality of first electrolyte-outtake blocking aperture;
the second outer frame is further provided with a plurality of inlets and a plurality of third outlets;
each third inlet is in communication with a corresponding first electrolyte-intake blocking aperture, and arranged at a position corresponding to the flow channel aperture in the third arch-like flow channel; and
the third outer is in communication with the first electrolyte-outtake blocking aperture, and arranged at a position corresponding to the flow channel aperture in the fourth arch-like flow channel.

6. The cell stack according to claim 5, wherein a first annular groove is formed at a periphery of each of the first inlets and the first outlets in the first end surface of the first outer frame;
a second annular groove is formed at a periphery of each of the first electrolyte-intake blocking apertures and the first electrolyte-outtake blocking apertures;
a third annular groove is formed at a periphery of each of the third inlets and the third outlets in the first end surface of the second outer frame; and
a fourth annular groove is formed at a periphery of each of the second inlets and the second outlets in the second end surface of the second outer frame.

7. The cell stack according to claim 5, wherein the first end surface of the first outer frame is provided with a plurality of first flow channels, and the second end surface of the first outer frame is provided with a plurality of second inlet flow channels and a plurality of second outlet flow channels;
each second inlet flow channel is in communication with one first inlet and one first cavity; and
each second outlet flow channel is in communication with one first outlet and one first cavity.

8. The cell stack according to claim 5, wherein the first end surface of the second outer frame is provided with a plurality of third inlet flow channels and a plurality of third outlet flow channels, each third inlet flow channel is in communication with one second inlet, and each third outlet flow channel is in communication with one second outlet; and
the second end surface of the second outer frame is provided with a plurality of fourth inlet flow channels and a plurality of fourth outlet flow channels, each fourth inlet flow channel is in communication with one third inlet and one second cavity, and each fourth outlet flow channel is in communication with one third outlet and one second cavity.

9. The cell stack according to claim 4, wherein the second assembly comprises a second bipolar plate, a third outer frame sleeved onto the second bipolar plate, and a second current collector in contact with the second bipolar plate, wherein the second end surface of the third outer frame is fixedly coupled to the second flow channel end plate, and the first end surface of the third outer frame is fixedly coupled to the third assembly.

10. The cell stack according to claim 9, wherein the third outer frame is provided with a plurality of fourth inlets and a plurality of fourth outlets, and the first end surface of the third outer frame is provided with a plurality of second electrolyte-intake blocking apertures and a plurality of second electrolyte-outtake blocking apertures;
each fourth inlet is arranged at a position corresponding to, and in communication with, the flow channel aperture in the third arch-like flow channel, and each fourth outlet is arranged at a position corresponding to, and in communication with, the flow channel aperture in the fourth arch-like flow channel; and
the second electrolyte-intake blocking aperture is arranged at a position corresponding to the flow channel aperture in the first arch-like flow channel, and the second electrolyte-outtake blocking aperture is arranged at a position corresponding to the flow channel aperture in the second arch-like flow channel.

11. The cell stack according to claim 10, wherein a fifth annular groove is formed at a periphery of each of the fourth inlets and the fourth outlets in the second end surface of the third outer frame, and a sixth annular groove is formed at a periphery of each of the second electrolyte-intake blocking apertures and the second electrolyte-outtake blocking apertures in the first end surface of the third outer frame.

12. The cell stack according to claim 11, wherein the second end surface of the third outer frame is provided with a plurality of fifth flow channels, the first end surface of the third outer frame is provided with a plurality of sixth inlet flow channels and a plurality of sixth outlet flow channels, each sixth inlet flow channel is in communication with one fourth inlet, and each sixth outlet flow channel is in communication with one fourth outlet.

13. The cell stack according to claim 9, wherein the third assembly comprises a fourth bipolar plate, a fifth electrode, a fifth outer frame, a third separator, a sixth electrode, a sixth outer frame, a fifth inner frame and a sixth inner frame;
the fifth outer frame is sleeved onto the fifth electrode, a first end surface of the fifth outer frame is provided with a third installation platform, and the fourth bipolar plate is fixed on the third installation platform;
the fifth inner frame is sleeved onto the fifth electrode, and the second end surface of the fifth inner frame is attached to the second end surface of the fifth outer frame;
the fifth outer frame is assembled with the fifth inner frame to form a plurality of fourth cavities in communication with the fifth electrode;
the third separator is arranged between the fifth electrode and the sixth electrode, and coupled to the fifth electrode, the sixth electrode, the first end surface of the fifth inner frame and a first end surface of the sixth outer frame;
each of the fifth inner frame and the sixth outer frame is sleeved onto the sixth electrode;
a second end surface of the sixth inner frame is attached to a second end surface of the sixth outer frame, and the sixth outer frame is assembled with the sixth inner frame to form a plurality of fifth cavities in communication with the sixth electrode; and
the second end surface of the fifth outer frame is fixed coupled to the first end surface of the sixth outer frame, the first end surface of the fifth outer frame is fixedly coupled to the second end surface of the second outer frame, and the second end surface of the sixth outer frame is fixedly coupled to the first end surface of the third outer frame.

14. The cell stack according to claim 13, wherein the fifth outer frame is provided with a plurality of seventh inlets, a plurality of seventh outlets, a plurality of eighth inlets and a plurality of eighth outlets, each seventh inlet is arranged at a position corresponding to the flow channel aperture in the first arch-like flow channel, each seventh outlet is arranged at a position corresponding to the flow channel aperture in the second arch-like flow channel, each eighth inlet is arranged at a position corresponding to the flow channel aperture in the third arch-like flow channel, and each eighth outlet is arranged at a position corresponding to the flow channel aperture in the fourth arch-like flow channel.

15. The cell stack according to claim 14, wherein the sixth outer frame is provided with a ninth inlet arranged at a position corresponding to, and in communication with, the seventh inlet, a ninth outlet arranged at a position corresponding to, and in communication with, the seventh outlet, a tenth inlet arranged at a position corresponding to, and in communication with, the eighth inlet, and a tenth outlet arranged at a position corresponding to, and in communication with, the eighth outlet.

16. The cell stack according to claim 15, wherein an eighth annular groove is formed at a periphery of each of the seventh inlets and the seventh outlets in the first end surface of the fifth outer frame, a ninth annular groove is formed at a periphery of each of the eighth inlets and the eighth outlets in the second end surface of the fifth outer frame, a tenth annular groove is formed at a periphery of each of the tenth inlets and the tenth outlets in the first end surface of the sixth outer frame, and an eleventh annular groove is formed at a periphery of each of the ninth inlets and the ninth outlets in the second end surface of the sixth outer frame.

17. The cell stack according to claim 14, wherein the first end surface of the fifth outer frame is provided with a plurality of ninth inlet flow channels and a plurality of ninth outlet flow channels, each ninth inlet flow channel is in communication with one eighth inlet, and each ninth outlet flow channel is in communication with one eighth outlet and the second end surface of the fifth outer frame is provided with a plurality of tenth inlet flow channels and a plurality of tenth outlet flow channels, each tenth inlet flow channel is in communication with one seventh inlet and one fourth cavity, and each tenth outlet flow channel is in communication with one seventh outlet and one fourth cavity.

18. The cell stack according to claim 15, wherein the first end surface of the sixth outer frame is provided with a plurality of eleventh inlet flow channels and a plurality of eleventh outlet flow channels, each eleventh inlet flow channel is in communication with one ninth inlet, and each eleventh outlet flow channel is in communication with one ninth outlet; and
the second end surface of the sixth outer frame is provided with a plurality of twelfth inlet flow channels and a plurality of twelfth outlet flow channels, each twelfth inlet flow channel is in communication with one tenth inlet and one fifth cavity, and each twelfth outlet flow channel is in communication with one tenth outlet and one fifth cavity.

19. The cell stack according to claim 13, wherein each of the first cavity, the second cavity, the fourth cavity and the fifth cavity comprises a first groove and a second groove; and
the first groove is formed in each of the second end surface of the first inner frame, the second end surface of the second inner frame, the second end surface of the fifth inner frame and the second end surface of the sixth inner frame, and the second groove matching the first groove is formed in each of the second end surface of the first outer frame, the second end surface of the second outer frame, the second end surface of the fifth outer frame and the second end surface of the sixth outer frame.

20. A flow battery comprising the cell stack according to claim 1.
